(19) United States
(12) Patent Application Publication
(10) Pub. No.: US 2018/0105672 A1
(43) Pub. Date: Apr. 19, 2018

(54) MOULD-RELEASE AGENT COMBINATIONS

(71) Applicant: LANXESS Deutschland GmbH, Cologne (DE)

(72) Inventors: Tobias BENIGHAUS, Dusseldorf (DE); Detlev JOACHIMI, Krefeld (DE); Richard WEIDER, Leverkusen (DE)

(73) Assignee: LANXESS Deutschland GmbH, Cologne (DE)

(21) Appl. No.: 15/842,106

(22) Filed: Dec. 14, 2017

Related U.S. Application Data
(62) Division of application No. 15/000,292, filed on Jan. 19, 2016.
Application No. 15/000,292 is a division of application No. 13/717,751, filed on Dec. 18, 2012, now abandoned.

(30) Foreign Application Priority Data
Dec. 21, 2011 (EP) 11194964.0

(51) Int. Cl. C08K 5/00; C08K 5/20; C08L 77/02; C08K 5/103; B29C 33/60; C08K 5/10; C08K 5/098; C08K 5/101

(52) U.S. Cl. CPC C08K 5/0008; C08K 5/20; C08L 77/02; C08K 5/103; C08K 5/101; B29C 33/60; C08K 5/10; C08K 5/098

(57) ABSTRACT

A mould-release agent combination for plastics reduces adhesion between a molded polyamide and a mold in which the molded polyamide is formed. The mould-release agent combination includes at least one amide wax, at least one ester wax, and/or at least one saponified wax.

This application is a divisional of pending U.S. patent application Ser. No. 15/000,292, filed Jan. 19, 2016 with the same tile, which is a divisional of U.S. patent application Ser. No. 13/717,751 filed Dec. 18, 2012 and now abandoned, which is entitled to the right of priority of European Patent Application No. 11194964.0 filed Dec. 21, 2011, the contents of which are hereby incorporated by reference in their entirety.

The present invention is within the plastics sector and relates to mould-release agent combinations for processing thereof, where the plastic involves polyamide. The mould-release agent combinations comprise at least one amide wax and at least one ester wax and/or one saponified wax. The invention further relates to the use of these mould-release agent combinations for polyamides, to moulding compositions based on polyimide comprising these mould-release agent combinations, to processes for producing these polyimide-based moulding compositions, and also to mouldings and semifinished products to be produced therefrom.

### BACKGROUND OF THE INVENTION

Injection moulding is one of the conventional processes for producing mouldings made of thermoplastics. In this process, the injection moulding finally has to be removed from the mould. This step often involves high demoulding forces, because of strong adhesion between the quenched polymer melt and the mould wall. In order to avoid deformation of the moulding, demoulding has to be delayed until the cooling process has rendered the moulding sufficiently rigid. Strong adhesion between mould wail and moulding can therefore significantly lengthen the cycle time and increase the production costs of the moulding.

The prior art adds mould-release agents to thermoplastics and/or uses suitable mould-release agents for spraying into the injection moulds. The mould-release agents reduce the forces required for the demoulding process. It is assumed that the mould-release agents act at the surfaces at the interface between moulding and mould wall and thus reduce adhesion. Mould-release agents having this effect are also termed external lubricants.

Mould-release agents mostly exhibit not only this external lubricant effect but also an internal lubricant effect, and often increase the flowability of the melt. This makes it easier to fill the mould, permits filling of the mould under relatively mild processing conditions, and reduces the probability of local overheating due to exposure of the melt to excessive shear. Materials used as mould-release agents in thermoplastics, particularly in engineering thermoplastics, and in particular when polyamide is used, are usually long-chain carboxylic adds, and also their soaps, esters or amides, and other materials sometimes used are polar or nonpolar polyethylene waxes. Each of these mould-release agents exhibits different specific advantages and disadvantages in each thermoplastic.

In engineering thermoplastics, such as polyamide, long-chain carboxylic acids and their soaps enter into undesired transamidation or transesterification reactions with polymer chains at the high temperatures required in the injection-moulding process. These reactions lead to a reduction of the length of the polymer chains, and this has an adverse effect on the mechanical properties of the moulding. However, these mould-release agents are successful internal and external lubricants.

Esters and amides of long-chain carboxylic acids only rarely exhibit undesired side reactions in the melt, even at high temperatures, and do not therefore lead to chain degradation. However, these substances have good compatibility with engineering thermoplastics, and do not migrate to their surface to any substantial extent, and therefore also exhibit only relatively low effectiveness as mould-release agents.

Polyethylene waxes often exhibit insufficient effect as mould-release agents, and can moreover lead to formation of visible deposits on the surface of the moulding.

U.S. Pat. No. 5,563,190 A discloses phenolic resin compositions which comprise not only an organic filler and an inorganic filler, but also a mould-release agent combination based on an amide wax, on an ester wax and/or on a saponified wax, in each case with melting point in the range from 80-105 degrees Celsius.

EP 1 164 162 A1 describes thermoplasticaily processable moulding compositions made of at least one thermoplastic elastomer, where the mixture comprises at least one fatty acid amide ester wax, natural and/or synthetic silica and a montan wax.

EP 0 792 917 A1 describes thermoplastically processable polyurethanes comprising carboxylic amide ester wax.

WO 2004/083301 A1 discloses extrudable cellulose-reinforced resin-containing compositions inter alia comprising oxidized polyethylene wax, ester wax and amide wax.

It was an object of the present invention to find a mould-release agent for polyamides which, in comparison with mould-release agents hitherto conventionally used for polyamide, reduces adhesion between moulding and mould wall, and brings about no, or only slight, degradation of the chain length of the thermoplastic during processing.

This object was achieved through a mould-release agent combination of different mould-release agents which comprise A. at least one amide wax, and also B. at least one ester wax and/or C. at least one saponified wax.

### SUMMARY OF THE INVENTION

The present invention therefore provides mould-release agent combinations for polyamides comprising:
A. at least one amide wax and
B. at least one ester wax and/or
C. at least one saponified wax, where the saponified wax involves a compound of at least one anion of an aliphatic carboxylic acid having a chain length of more than 11 carbon atoms and of a cation, where the anion is obtained through deprotonation of the carboxylic acid, and ester wax used comprises the condensate of a monobasic aliphatic carboxylic acid having a chain length of more than 11 carbon atoms and of a monohydric alcohol.

In one preferred embodiment, the present invention provides mould-release agent combinations characterized in that these comprise at least one amide wax, at least one ester wax and at least one saponified wax.

For the purposes of the present invention, amide waxes are compounds which can be produced by means of a condensation reaction of long-chain carboxylic acids with mono- or polyfunctional amines. In one preferred embodiment, it is also possible to use carboxylic acids having hydroxy groups.

### DETAILED DESCRIPTION OF THE INVENTION

According to the invention it is preferable to use, for the synthesis of the amide waxes, branched or linear long-chain aliphatic carboxylic acids having more than 11 carbon atoms. It is particularly preferable that the chain length of the aliphatic carboxylic acids is from 12 to 36 carbon atoms. Very particular preference is given to aliphatic carboxylic acids of which the chain length is from 14 to 22 carbon atoms. Preference is in particular given to linear saturated aliphatic carboxylic acids having a chain length of from 14 to 22 carbon atoms. Particular preference is in particular given to the use of at least one carboxylic acid from the group of lauric acid, isotridecanoic acid, myristic acid, palmitic acid, margaric acid, stearic add, isostearic acid, arachic acid, behenic acid, lignoceric acid, cerotinic acid, montanic acid, melissic acid, myristoleic acid, palmitoleic acid, petroselic acid, oleic acid, elaidic acid, vaccenic acid, gadoleic acid, icosenic acid, cetoleic add, erucic acid, nervonic acid, linoleic acid, linolenic acid, calendic acid, elaeostearic add, punicic acid, arachidonic acid, timnodonic acid, clupanodonic add, cervonic acid, and also their technical mixtures. In particular, it is very particularly preferable to use at least one carboxylic add from the group margaric acid, stearic acid, arachic acid and behenic acid, in particular stearic acid.

The aliphatic carboxylic acids can be used alone or in a mixture. It is preferable to use industrial aliphatic carboxylic acids, where these normally take the form of a mixture of carboxylic acids having different chain length, where one chain length is predominant. It is particularly preferable to use industrial stearic add which comprises primarily stearic acid, and also relatively small amounts of palmitic acid and other carboxylic acids.

Mono- or polyfunctional amines used comprise alkylamines having one or more amine groups, where the amine groups can be of primary or secondary type and the alkyl component can be saturated or unsaturated, and can comprise further substituents. It is preferable to use alkylamines having terminal primary amine groups, and particular preference is given to linear saturated alkylamines having two terminal primary amine groups. Very particular preference is given to ethylenediamine.

In particular, it is particularly preferable to use ethylenebisstearamide as amide wax. In particular, very particular preference is given to using ethylenebisstearamide produced from industrial stearic acid, where this is a mixture of pure stearic acid with further carboxylic acids, primarily palmitic acid.

For the purposes of the present invention, ester waxes are compounds which can be produced by means of a condensation reaction of at least one long-chain monobasic, aliphatic carboxylic acid with an alcohol.

Ester waxes preferred according to the invention are esters of the aliphatic carboxylic acids previously described above and having more than 11 carbon atoms.

For the alcohol component of the ester wax, it is preferable to use unsaturated or saturated alkyl compounds having at least one hydroxy group, where the hydroxy groups are primary, secondary or tertiary. It is particularly preferable to use saturated alkyl compounds having from 1 to 8 primary or secondary hydroxy groups. It is very particularly preferable to use linear saturated alkyl compounds having from 1 to 4 primary or secondary hydroxy groups.

In particular, it is preferable to use at least one alcohol from the group of erythritol, pentaerythritol, dipentaerythritol, tripentaerythritol, trimethylolpropane, glycerol, diglycerol, triglycerol, xylitol, mannitol, sorbitol, ethylene glycol, 1,3 propylene glycol, 1,4-butanediol, 2,3-butanediol, 1,5-pentanediol, 1,6-hexanediol, lauryl alcohol, isotridecyl alcohol, myristyl alcohol, palmityl alcohol, daturyl alcohol, stearyl alcohol, isostearyl alcohol, arachyl alcohol, behenyl alcohol, lignoceryl alcohol, cerotyl alcohol, montanyl alcohol, or else industrial mixtures of these.

For the purposes of the present invention, saponified waxes are compounds of a cation and of at least one anion of an aliphatic carboxylic acid, where the anion is obtained through deprotonation of the carboxylic acid.

For the purposes of the invention, partially saponified waxes are also considered to be saponified waxes. Partially saponified waxes are mixtures of neutral aliphatic carboxylic acids with the salts described above made of carboxylic acid anions and cations.

For the production of the saponified waxes it is preferable to use long-chain aliphatic carboxylic acids already described above and having more than 11 carbon atoms.

Cations preferably used are those which derive from the elements of the group consisting of all of the alkali metals and alkaline earth metals, and also zinc and aluminium, and which are therefore usually present in the formal oxidation states +1, +2 or +3. The saponified waxes are therefore preferably composed of one of these cations and also respectively 1, 2 or 3 carboxylic acid anions, according to the oxidation states of the cation, in such a way that the compound has no net electrical charge. It is particularly preferable to use the cations of an element from the group consisting of lithium, sodium, potassium, magnesium, calcium, barium, aluminium and zinc.

Saponified waxes used with particular preference comprise lithium stearate, sodium stearate, potassium stearate, magnesium stearate, calcium stearate, barium stearate, aluminium stearate or zinc stearate, and in particular very particularly preferably comprise calcium stearate.

The components can be present in any desired ratio in the mould-release agent combinations according to the invention. Preference is given to mould-release agent combinations which comprise
A. from 10 to 90% by weight, particularly preferably from 20 to 70% by weight, very particularly preferably from 30 to 50% by weight, of at least one amide wax,
B. from 10 to 90% by weight, particularly preferably from 20 to 60% by weight, very particularly preferably from 30 to 50% by weight, of at least one ester wax.

If a saponified wax is used as component C., the amount used of at least one saponified wax, either in addition to components A. and B., or instead of component B., is from 5 to 50% by weight, particularly preferably from 10 to 40% by weight, very particularly preferably from 15 to 35% by weight, where the sum of all of the percentages by weight for the mould-release agent combination then to be used in the polyamide is always 100.

The invention therefore preferably provides mould-release agent combinations characterized in that they comprise
A. from 5-70% by weight, preferably from 20-70% by weight, particularly preferably from 30-50% by weight, of at least one amide wax,
B. from 5-70% by weight, preferably from 20-60% by weight, particularly preferably from 30-50% by weight, of at least one ester wax, and/or
C. from 5-50% by weight, preferably from 10-40% by weight, particularly preferably from 15-35% by weight, of at least one saponified wax, where the sum of all the percentages by weight of the mould-release agent combination is always 100.

The release-agent combinations according to the invention can have any desired further ingredients alongside the components amide waxes, ester waxes and/or saponified waxes. It is preferable that these ingredients are usually used as mould-release agents for plastics. Preferred additional mould-release agents of component D. are polar and nonpolar polyethylene waxes, alpha-olefins, fatty acids or fatty acid alcohols. Use of component D. leads to a corresponding reduction in the percentages by weight of components A., B., and/or C., in such a way that the sum of all of the percentages by weight in the mould-release agent combination is always 100.

Fatty acids preferably to be used as additional mould-release agents of component D. are lauric acid, isotridecanoic acid, myristic acid, palmitic acid, margaric acid, stearic acid, isostearic acid, arachic acid, behenic acid, lignoceric acid, cerotinic acid, montanic acid and melissic acid.

Fatty acid alcohols preferably to be used as mould-release agents of component D. are lauryl alcohol, isotridecyl alcohol, myristyl alcohol, palmityl alcohol, daturyl alcohol, stearyl alcohol, isostearyl alcohol, arachyl alcohol, behenyl alcohol, lignoceryl alcohol, cerotyl alcohol, montanyl alcohol.

Preferred non-polar polyethylene waxes to be used as component D are produced through polymerization of ethylene or degradation of polyethylene. The polymerization process can use not only ethylene but also other comonomers. Preferred comonomers have from 2 to 10 carbon atoms and at least one double bond between two carbon atoms. Particularly preferred comonomers are propene, butene, butadiene, pentene, pentadiene, hexene and hexadiene.

Preferred polar polyethylene waxes are produced through oxidation of non-polar polyethylene waxes, or through polymerization of ethylene with polar comonomers or grafting of polar unsaturated monomers onto polyethylene. Preferred comonomers have from 2 to 10 carbon atoms and at least one double bond between two carbon atoms, and also one polar group. Particularly preferred comonomers are acrylic acid, acrylic esters, methacrylic esters and vinyl acetate. A particularly preferred polar polyethylene wax is Licolub H12 from Clariant GmbH.

Alpha-olefins preferably to be used as component D. are linear or branched, and have a chain length of at least 12 carbon atoms, particularly preferably of at least 18 carbon atoms.

Preference is given to mould-release agent combinations in which the proportion of components other than amide waxes, ester waxes or saponified waxes is smaller than 25% by weight, particularly preferably smaller than 10% by weight. Very particular preference is given to mould-release agent combinations which comprise exclusively amide waxes, ester waxes and/or saponified waxes, i.e. comprise components A., B. and/or C.

In one preferred embodiment, the present invention provides mould-release agent combinations of different mould-release agents which comprise at/east A. one amide wax, and also B. one ester wax and/or C. one saponified wax, where amide wax used comprises ethylenebisstearylamide, ester wax used comprises glycerol tristearate or stearyl stearate and saponified wax used comprises calcium stearate.

The present invention therefore also provides the use of mould-release agent combinations of this type for the demoulding of polyamide-based plastics, particularly preferably of polyamide-based or copolyamide-based moulding compositions, very particularly preferably of nylon-6- or nylon-6,6- or copolyamide-based moulding compositions, or of the products to be produced therefrom.

The present invention further provides a process for producing thermoplastic moulding compositions based on polyamides comprising the mould-release agent combinations according to the invention.

The process according to the invention preferably uses polyamides already present in polymer form. The mixing (compounding) of the components of the polyamide-based thermoplastic moulding composition preferably takes place at from 220 to 360° C. through combination mixing, kneading, compounding, extrusion or rolling of the polyamide together with the mould-release agent combination according to the invention, and particularly preferably through compounding in a corotating twin-screw extruder or a Buss kneader. It can be advantageous to premix selected components, or all of the components.

It is preferable that the individual mould-release agents A., B. and/or C., and also in another embodiment D., are first mixed in their respective supply form, and are added in the form of mould-release agent combination to the polyamide. The homogenization of the mould-release agent combination is necessary only to the extent that the mould-release agents have uniform distribution in the polyamide moulding compositions after production of these. Uniform distribution of the mould-release agents in the polyamide moulding compositions can also be achieved by adding the individual mould-release agents separately to the polyamide. Processes of this type are therefore also provided by the present invention. Particular preference is given to a process in which the components of the mould-release agent combination are mixed and subjected to a finishing process, and then the mould-release agent combination is added to the polyamide. Very particular preference is given to a process in which

1. the components of the mould-release agent combination are melted,
2. are mixed in the molten state,
3. are cooled until solidification occurs,
4. are subjected to a finishing process, and
5. are added to the polyamide.

It is preferable that steps 1 to 4 of this process are carried out in a corotating twin-screw extruder or Buss kneader. It is particularly preferable that the temperature at which this takes place in the extruder or kneader is above the melting point of that component of the mould-release agent combination that has the highest melting point.

For the purposes of this invention, a finishing process is any process which converts the mixture of the mould-release agents to a supply form which leads to simple processing during the production of the polyamide moulding compositions. Preference is given to those supply forms which have only a small proportion of fine particles or which form only a small proportion of fine particles during transport, or during conveying or metering or other types of processing. Particles considered here to be fine particles are those having a length below 500 μm along one spatial direction, preferably below 200 μm, particularly preferably below 100 μm. A proportion considered to be small is a proportion of less than 10% by weight, preferably less than 5% by weight, particularly preferably less than 2% by weight. Preferred processes are the compacting of powders with or without additional binders, the pelletization of a melt strand, the separation of a melt into drops to produce prills or the breaking of a solidified melt to give flakes.

The present invention therefore provides a process for producing polyamides including mould-release agent combinations, including the steps of:
a) mixing at least two mould-release agents A. and B. and/or C. to give a mould-release agent combination and
b) adding the mould-release agent combination to the plastic, where the thermoplastic involves polyamide.

In one preferred embodiment, the present invention provides a process where, prior to the addition of the plastic, the mould-release agents A., B. and/or C. are melted, mixed in the molten state to give the mould-release agent combination, and cooled until solidification occurs, and then the mould-release agent combination is subjected to a finishing process.

The moulding compositions to be produced according to the invention can be processed by processes known to the person skilled in the art, in particular through extrusion, blow moulding or injection moulding, to give products. It can moreover be advantageous to produce mouldings or semifinished products directly from a physical mixture (dryblend) produced at room temperature, preferably from 0 to 40° C., of premixed components and/or of individual components.

The thermoplastic is preferably a semicrystalline polyamide. It is particularly preferable that the mould-release agent combination according to the invention is used in polyamides which are used in technical applications, and it is very particularly preferable that it is used in semicrystalline polyamides with a melting point of at least 180° C. or in amorphous polyamides with a glass transition temperature of at least 150° C.

Particular preference is given to nylon-6 or nylon-6,6 or copolyamides based on nylon-6 and/or nylon-6,6, or blends of these polyamides with other thermoplastic polymers, in particular from the group of polyphenylene oxide, polyethylene and polypropylene.

In one preferred embodiment, the thermoplastic can also be a blend of various thermoplastic polymers, of which at least one is polyamide.

The present invention further provides the use of mould-release agent combinations according to the invention for polyamides and for products to be produced therefrom, in particular mouldings and semifinished products. The mould-release agent combinations are preferably used as mould-release agents, but can also be used as internal lubricants for improving the flowability of the polymer melt. They can also be used in order to convert other ingredients which are added to the polyamide into another supply form. In one preferred embodiment, the mould-release agent combinations can be used as binders for the compacting of powders or as carrier of a masterbatch.

The present invention further provides thermoplastic moulding compositions based on polyamide comprising the mould-release agent combinations according to the invention. in one preferred embodiment, the polyamide moulding compositions comprise not only the mould-release agent combination and the polyamide but also fillers or reinforcing materials and/or further additives.

Fillers and reinforcing materials preferably to be used according to the invention are mineral fillers, in particular calcium carbonate, wollastonite, phlogopite, muscovite, kaolin, talc powder, calcium sulphate, barium sulphate, and also glass fibres, carbon fibres, aramid fibres, carbon nanotubes, and hollow or solid glass beads.

Further additives to be used according to the invention are preferably heat stabilizers, UV stabilizers, gamma-radiation stabilizers, hydrolysis stabilizers, antistatic agents, emulsifiers, nucleating agents, plasticizers, processing aids, impact modifiers, lubricants, dyes or pigments. The additives mentioned and other suitable additives are prior art and can be found by the person skilled in the art by way of example in Plastics Additives Handbook, 5th Edition, Hanser-Verlag, Munich, 2001, pp. 80-84, 546-547, 688, 872-674, 938, 966. The additives can be used alone or in a mixture, or in the form of masterbatches.

Preferred heat stabilizers to be used as additive according to the invention in the polyamide moulding compositions are not only copper compounds, in particular copper halides in combination with alkali metal halides, but also sterically hindered phenols and/or phosphites, hydroquinones, aromatic secondary amines, in particular diphenylamines, substituted resorcinols, salicylates, benzotriazoles or benzophenones, and also variously substituted members of these groups, and/or mixtures thereof.

UV stabilizers preferably to be used as additive according to the invention are substituted resorcinols, salicylates, benzotriazoles or benzophenones.

Impact modifiers or elastomer modifiers preferably to be used according to the invention very generally involve copolymers preferably composed of at least two monomers from the group of ethylene, propylene, butadiene, isobutane, isoprene, chloroprene, vinyl acetate, styrene, acrylonitrile and acrylic or methacrylic esters having from 1 to 18 carbon atoms in the alcohol component. In one preferred embodiment, the copolymers comprise compatibilizing groups, preferably maleic anhydride or epoxy.

Dyes or pigments preferably to be used as additive according to the invention are inorganic pigments, particularly preferably titanium dioxide, ultramarine blue, iron oxide, zinc sulphide or carbon black, and also organic pigments, particularly preferably phthalocyanines, quinacridones, perylenes, and also dyes, particularly preferably nigrosin or anthraquinones, and also other colorants.

Nucleating agents preferably to be used as additive according to the invention are sodium phenylphosphinate or calcium phenylphosphinate, aluminium oxide or silicon dioxide or talc powder, particularly preferably talc powder.

It will be understood that the specification and examples are illustrative but not limitative of the present invention and that other embodiments within the spirit and scope of the invention will suggest themselves to those skilled in the art.

### Examples

In order to demonstrate the improvements described according to the invention, appropriate plastics moulding compositions were first prepared through compounding.

The individual components were mixed in a ZSK 32 Compounder twin-screw extruder from Coperion Werner & Pfleiderer (Stuttgart, Germany) at a temperature of about 280° C., discharged in the form of strand into a water bath, cooled until pelletizable, and pelletized. The pellets were dried for two days at 70° C. in a vacuum drying oven.

All of the compositions described in the two tables below were processed in the manner described above.

In order to determine the mould-release effect, coefficients of static and sliding friction (Tables 3 and 4), and also demoulding forces on a component (Tables 1 and 2) were measured for mould-release agent combinations according to the invention and not according to the invention.

Demoulding forces were determined by producing a rectangular moulding with reinforcing ribs by the injection-moulding process, and recording the forces required at the ejector for the demoulding process. The melt temperature at which the thermoplastic moulding compositions were injected into the mould was 280° C. (at the die). The mould was controlled to a temperature of 80° C. After a hold-pressure time of 8 seconds at a hold pressure of 350 bar, the moulding was cooled for 20 seconds and then demoulded. The demoulding process used 12 demoulding pins, which were pneumatically moved simultaneously by way of a metal plate. The forces required to force the 12 demoulding pins against the moulding and thus demould the moulding were recorded electronically by way of a force sensor. The highest force arising was considered to be the demoulding force.

The flow velocity of the melt depends on the polymer-chain length, alongside other factors. The change in average polymer-chain length on exposure to heat was therefore determined by way of the change in volume flow rate (melt volume rate, MVR) after various periods of exposure to heat. At high temperatures and in the presence of water molecules, polyamide-polymer chains can undergo degradation reactions which lead to reduction of average polymer-chain length and thus to an increase of the MVR value. The compositions in the examples below were therefore moistened until a comparable water content of about 0.15% by weight was achieved for all of the specimens. MVR values were then determined with preheat times of 5 and 20 minutes at 280° C. with a nominal load of 5 kg in accordance with DIN EN ISO 1133. The difference between the MVR values after 5 and 20 minutes of preheat time was used as a measure of the degradation of the polymer: the greater the MVR difference, the greater the undesired polymer degradation.

TABLE 1
Composition of the reinforced moulding compositions (data in % by weight),
demoulding forces and MVR differences

| | Comp. | Comp. | Comp. | Comp. | Comp. | Comp. | Comp. | Inv. | Inv. | Inv. | Inv. |
|---|---|---|---|---|---|---|---|---|---|---|---|
| Ingredients | Ex. 1 | Ex. 2 | Ex. 3 | Ex. 4 | Ex. 5 | Ex. 6 | Ex. 7 | Ex. 1 | Ex. 2 | Ex. 3 | Ex. 4 |
| Copolyamide | 84.78 | 84.68 | 84.78 | 84.68 | 84.78 | 84.78 | 84.78 | 84.78 | 84.75 | 84.75 | 84.78 |
| Glass fibre | 15 | 15 | 15 | 15 | 15 | 15 | 15 | 15 | 15 | 15 | 15 |
| Talc powder | 0.02 | 0.02 | 0.02 | 0.02 | 0.02 | 0.02 | 0.02 | 0.02 | 0.02 | 0.02 | 0.02 |
| Ca stearate | 0.2 | 0.3 | | | | | | 0.1 | 0.07 | 0.06 | 0.05 |
| Ethylenebis- | | | 0.2 | 0.3 | | | 0.08 | 0.05 | 0.05 | 0.17 | 0.05 |
| stearylamide | | | | | | | | | | | |
| Glycerol | | | | | 0.2 | | | 0.05 | 0.06 | | 0.05 |
| tristearate | | | | | | | | | | | |
| Stearyl | | | | | | 0.2 | | | | | 0.05 |
| stearate | | | | | | | | | | | |
| ox. PE wax | | | | | | | 0.12 | | 0.05 | | |
| Demoulding | 1325 | 1298 | 1554 | 1438 | 1857 | 1524 | 1314 | 1064 | 1032 | 1098 | 1012 |
| force [N] | | | | | | | | | | | |
| MVR | 50 | 61 | 29 | 25 | 20 | 21 | 23 | 21 | 32 | 21 | 26 |
| difference | | | | | | | | | | | |
| [cm³/10 min] | | | | | | | | | | | |

TABLE 2
Composition of the unreinforced moulding compositions (data
in % by weight), demoulding forces and MVR differences.

| | Comp. | Comp. | Inv. |
|---|---|---|---|
| Ingredients | Example 8 | Example 9 | Example 5 |
| PA66 | 99.54 | 99.54 | 99.54 |
| Talc powder | 0.06 | 0.06 | 0.06 |
| Ca stearate | 0.4 | | 0.1 |
| Ethylenebisstearylamide | | 0.4 | 0.1 |
| Glycerol tristearate | | | 0.1 |
| Stearyl stearate | | | 0.1 |
| ox. PE wax | | | |
| Demoulding force [N] | 873 | 895 | 809 |
| MVR difference | 126 | 41 | 74 |
| [cm³/10 min] | | | |

These examples show that mould-release agent combinations according to the invention lead to markedly reduced demoulding forces. Similar reductions of demoulding force cannot be achieved with conventional mould-release agents even with concentration increases of 50% (Comparative Examples 2 and 4). Combinations of mould-release agents not according to the present invention also exhibit a significantly poorer demoulding effect (Comparative Example 7).

Among the conventional mould-release agents in these examples, calcium stearate exhibits the best demoulding effect. However, the MVR difference results provide evidence that calcium stearate leads to marked degradation of the polymer chains (Comparative Examples 1, 2, 8). The other conventional mould-release agents (amide waxes and ester waxes) exhibit better MVR difference results and lead only to slight chain degradation. However, their demoulding effect is markedly poorer (Comparative Examples 3-7, 9). The demoulding performance of the mould-release agent combinations according to the invention is always better than that of the individual mould-release agents. At the same time, the MVR difference values are at a level similar to that for the amide waxes or ester waxes, where these do not cause any marked chain degradation.

The adhesion of the moulding on the mould is determined inter alia by the coefficients of static and sliding friction. Ease of demoulding therefore correlates with low values for the coefficients of static and sliding friction.

The coefficients of static and sliding friction were determined by producing circular test discs with a diameter of 95 mm with a toothed external ring, by the injection-moulding process. A specific design of the mould permits measurement of the coefficients of static and sliding friction without demoulding of the test disc: during cooling of the moulding, a defined pressure is applied from one side to the test disc by way of a ram, and then the mould is opened on this side and the sprue is broken away. During these procedures, the moulding does not separate from the other side of the mould. Finally, the test disc is rotated by way of the toothed outer ring, and the required torque is recorded. The coefficients of static and sliding friction are determined from these data. EP1377812 B1 describes this method in detail.

TABLE 3
Composition of the reinforced moulding compositions (data
in % by weight), coefficients of static and sliding friction

| | Comp. | Comp. | Inv. |
|---|---|---|---|
| | Example | Example | Example |
| Ingredients | 10 | 11 | 6 |
| PA6 | 69.696 | 69.696 | 69.696 |
| Talc powder | 0.02 | 0.02 | 0.02 |
| Glass fibre | 30 | 30 | 30 |
| Copper(I) iodide | 0.04 | 0.04 | 0.04 |
| Potassium bromide | 0.1 | 0.1 | 0.1 |
| Ca stearate | 0.144 | | 0.036 |
| Ethylenebisstearylamide | | 0.144 | 0.058 |
| Stearyl stearate | | | 0.05 |
| Coefficient of | 0.08 | 0.11 | 0.08 |
| static friction | | | |
| Coefficient of | 0.08 | 0.1 | 0.08 |
| sliding friction | | | |

TABLE 4
Composition of the unreinforced moulding compositions (data
in % by weight), coefficients of static and sliding friction

| | Comp. | Comp. | Inv. |
|---|---|---|---|
| | Example | Example | Example |
| Ingredients | 12 | 13 | 7 |
| PA6 | 99.575 | 99.575 | 99.575 |
| Talc powder | 0.025 | 0.025 | 0.025 |
| Ca stearate | 0.4 | | 0.1 |
| Ethylenebisstearylamide | | 0.4 | 0.16 |
| Stearyl stearate | | | 0.14 |
| Coefficient of | 0.73 | 1.39 | 0.61 |
| static friction | | | |
| Coefficient of | 0.68 | 1.01 | 0.48 |
| sliding friction | | | |

In the examples of a reinforced nylon-6 moulding composition (Table 3), the values for coefficients of static and sliding friction with use of calcium stearate (Comparative Example 10) and of a mould-release agent combination according to the invention (Example 6) are at a similar level. However, the mould-release agent combinations according to the invention have the advantage of not leading to any degradation of the polymer chains (see Comparative Examples 1, 2 and 8). The moulding composition with amide wax as mould-release agent (Comparative Exempla Example 11) exhibits increased values for static and sliding friction.

In the examples of unreinforced nylon-6 moulding compositions (Table 4), the moulding composition with the mould-release agent combination according to the invention (Example 7) exhibits the lowest values for coefficients of static and sliding friction. With calcium stearate (Comparative Example 12) or amide wax (Comparative Example 13) as mould-release agent, these values are slightly (calcium stearate) or markedly (amide wax) higher.

### Materials Used:

Copolyamide, composed of polycaprolactam comprising about 5% of PA66 units, linear with a relative solution viscosity of 2.9 for a 1% solution in m-cresol, e.g. 5011B nylon from Ube
Nylon-6,6, linear with a relative solution viscosity of 3.0 for a 1% solution in m-cresol, e.g. Zytel 101 NC010
Nylon-6, linear with a relative solution viscosity of 2.9 for a 1% solution in m-cresol
Potassium bromide, d₉₉<70 μm
Copper(I) iodide, d₉₉<70 μm
Talc powder
Calcium stearate, e.g. Ceasit AV from Baerlocher GmbH
Ethylenebisstearylamide, e.g. Acrawax C from Lonza Group Ltd.
Glycerol tristearate, e.g. Ligalub GT from Peter Greven GmbH & Co. KG
Stearyl stearate, e.g. Ligalub 36 FE from Peter Greven GmbH & Co. KG
Oxidized polyethylene wax, e.g. Licolub H12 from Clariant GmbH

What is claimed is:

1. A method for reducing adhesion between a molded polyamide and a mold in which the molded polyamide is formed, the method comprising:
mixing a liquid polyamide with a mould-release agent combination comprising:
30-50 wt % of an amide wax;
30-50 wt % of an ester wax comprising a condensate of a monobasic aliphatic carboxylic acid having a chain length of more than 11 carbon atoms and of a monohydric alcohol; and
15-35 wt % of a saponified wax comprising a compound of at least one anion of an aliphatic carboxylic acid having a chain length of more than 11 carbon atoms and of a cation, where the anion is obtained through deprotonation of the carboxylic acid,
to produce a polyamide mixture; and
introducing the polyamide mixture into a mold and molding the polyamide within the mold, wherein the molded polyamide has less adhesion to the mold than the same polyamide with any one of the same waxes.

2. The method according to claim 1, wherein:
the polyamide is nylon-6 or nylon-6,6, or their copolyamides, or blends thereof;
the amide wax is ethylene-bisstearylamide;
the ester wax is glycerol tristearate or stearyl stearate; and
the saponified wax is calcium stearate.

3. The method according to claim 2, wherein the ester wax is stearyl stearate.

4. The method according to claim 3, wherein the mould-release agent combination further comprises at least one of polar polyethylene waxes, nonpolar polyethylene waxes, alpha-olefins, fatty acids, and fatty acid alcohols in an amount of >0 to <25 wt %.

5. The method according to claim 4, wherein the mould-release agent combination further comprises oxidized polyethylene wax in an amount of >0 to <25 wt %.

6. The method according to claim 1, wherein the mould release agent combination consists of the amide wax, the ester wax, and the saponified wax.

7. The method according to claim 1, wherein the mould-release agent combination consists of:
30-50 wt % of the amide wax;
30-50 wt % of the ester wax; and
15-35 wt % of the saponified wax.

8. The method according to claim 1, wherein the mould-release agent combination consists of:
30-50 wt % of ethylene-bisstearylamide;
30-50 wt % of glycerol tristearate or stearyl stearate; and
15-35 wt % of calcium stearate.

9. The method according to claim 1, wherein the mould release agent combination consists of:
30-50 wt % of ethylene-bisstearylamide;
30-50 wt % of stearyl stearate; and
15-35 wt % of calcium stearate.

10. The method according to claim 1, wherein the mould-release agent combination comprises:
5-70 wt % of an amide wax;
5-70 wt % of an ester wax comprising a condensate of a monobasic aliphatic carboxylic acid having a chain length of more than 11 carbon atoms and of a monohydric alcohol;
5-50 wt % of a saponified wax comprising a compound of at least one anion of an aliphatic carboxylic acid having a chain length of more than 11 carbon atoms and of a cation, where the anion is obtained through deprotonation of the carboxylic add; and
>0 to <25 wt % of at least one of polar polyethylene waxes, nonpolar polyethylene waxes, alpha-olefins, fatty acids, and fatty acid alcohols.

11. The method according to claim 10, wherein the at least one of polar polyethylene waxes, nonpolar polyethylene waxes, alpha-olefins, fatty acids, and fatty acid alcohols is oxidized polyethylene wax.

12. The method according to claim 1, wherein the mould release agent combination consists of:
30-50 wt % of ethylene-bisstearylamide;
30-50 wt % of glycerol tristearate or stearyl stearate;
15-35 wt % of calcium stearate; and
>0 to <25 wt % of oxidized polyethylene wax.
